(19) United States
(12) Patent Application Publication
(10) Pub. No.: US 2024/0375764 A1
(43) Pub. Date: Nov. 14, 2024

(54) ROTOR HUB SYSTEMS AND METHODS

(71) Applicant: SUPERNAL, LLC, Washington, DC (US)

(72) Inventors: Bryan Marshall, Mansfield, TX (US); Kristopher Haydel, Fort Worth, TX (US)

(73) Assignee: SUPERNAL, LLC, Washington, DC (US)

(21) Appl. No.: 18/692,078

(22) PCT Filed: Sep. 14, 2022
(86) PCT No.: PCT/US2022/076429

§ 371 Date: Mar. 14, 2024

Related U.S. Application Data
(60) Provisional application No. 63/261,279, filed on Sep. 16, 2021.

(51) Int. Cl. B64C 11/06; B64C 27/35

(52) U.S. Cl. CPC B64C 11/06; B64C 27/35

(57) ABSTRACT

Embodiments of the present disclosure provide systems and methods for a hub. The system provides a hub comprising at least two blades, a motor mechanically connected to the at least two blades to rotate the at least two blades, wherein the motor is attached to an frame; and a hub configured to transmit loads from the at least two blades to the frame, wherein each blade is coupled to an inboard elastomeric bearing attached to the hub, and wherein each blade is coupled to an outboard elastomeric bearing attached to the hub. The hub may comprise a pitch horn configured to couple one of the at least two rotor blades at an attachment to the inboard elastomeric bearing.

### FIELD OF THE INVENTION

The presently disclosed subject matter generally relates to a rotor hub or rotor hub assembly.

### BACKGROUND

A variety of vehicles are currently known to those skilled in the art that use a rotor or a proprotor to generate thrust, including for example, vehicles or boats propelled or pulled by a rotor or proprotor. Aircraft, for example, can include general categories of horizontal thrust aircraft (e.g., fixed wing aircraft) and vertical thrust aircraft (e.g., helicopters), or a combination of the two (such as a “vertical take off and landing” or “VTOL”). As a person of ordinary skill in the art will realize, all of these vehicles can use hubs to control and transfer power to a rotor or proprotor that is used to generate propulsion in horizontal and/or vertical planes.

As noted above, some aircraft may include a blade or blades capable of being positioned in a substantially vertical orientation that allows the aircraft to achieve vertical take-off, or positioned in a substantially horizontal orientation that allows the aircraft to fly substantially horizontal (i.e., in a direction substantially parallel to the earth's surface). In such aircraft, a load created by the rotation of the blade may be transferred to the airframe through a hub. Portions of the hub may rotate with the blades, and portions of the hub may change pitch with the blade while other portions do not change pitch with the blades.

Efficient load transmission for aircraft using rotors or proprotors is desirable for a number of reasons, including for example to keep the weight and space requirements of the hub to a minimum, which may also reduce drag. Additionally, duplicative load paths are desirable so that the hub may handle a number of safety events, including for example, by providing an alternative load path if a primary load path fails during aircraft operation. Moreover, it is further desirable to reduce the number of components used to generate propulsion so as to reduce maintenance and replacement costs.

### SUMMARY

Briefly described, embodiments of the presently disclosed subject matter relate to systems and methods for a hub assembly.

An exemplary aspect of this disclosure relates to a hub assembly. According to some embodiments, the hub assembly may comprise at least two blades, a motor mechanically connected to the at least two blades to rotate the at least two blades, wherein the motor is attached to a frame; a hub configured to transmit loads from the at least two blades to the frame, wherein one blade of the at least two blades is coupled to an inboard elastomeric bearing attached to the hub and coupled to an outboard elastomeric bearing attached to the hub. In some embodiments, the hub may be configured to operate in two configurations that are substantially perpendicular to each other.

In some embodiments, the hub may comprise a pitch horn configured to couple one of the at least two rotor blades at an attachment to the inboard elastomeric bearing. In some embodiments, the hub may comprise a link configured to couple the pitch horn to a pitch controller. In some embodiments, the hub may be configured to transmit a substantially in-plane force from the inboard elastomeric bearing and the outboard elastomeric bearing to the one blade. In some embodiments, the inboard elastomeric bearing may be configured to bear the centrifugal force of one of the at least two rotor blades in compression. In some embodiments, the outboard elastomeric bearing may be configured to bear a centrifugal force of one of the at least two rotor blades if the inboard elastomeric bearing fails to bear the centrifugal force of the one blade. In some embodiments, the inboard elastomeric bearing and the outboard elastomeric bearing may allow for a change in pitch of the hub. In some embodiments, the inboard elastomeric bearing and the outboard elastomeric bearing may be each configured to allow for a change in pitch of one of the at least two rotor blades. In some embodiments, the frame may comprise a sensor configured to sense a failure mode of one or more of the inboard elastomeric bearing and the outboard elastomeric bearing.

An exemplary aspect of this disclosure relates to a method of providing lift or thrust to a vehicle, the method comprising steps of: transmitting power from a motor to at least two blades through a drive shaft, supporting one blade of the at least two blades through a hub comprising an inboard elastomeric bearing and an outboard elastomeric bearing, wherein the one blade is attached to the inboard elastomeric bearing and the outboard elastomeric bearing; transmitting a substantially out-of-plane force from the one blade to the inboard elastomeric bearing and the outboard elastomeric bearing; and transmitting a substantially in-plane force to the inboard elastomeric bearing and the outboard elastomeric bearing. In some embodiments, one of the at least two rotor blades may comprise a first flange and a second flange, and wherein the inboard elastomeric bearing and the outboard elastomeric bearing are between the first flange and the second flange.

The foregoing summarizes only a few aspects of the presently disclosed subject matter and is not intended to reflect the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 illustrates a hub assembly according to some embodiments of the present disclosure.

FIG. 2 illustrates a hub assembly according to some embodiments of the present disclosure.

FIG. 3 illustrates a hub assembly according to some embodiments of the present disclosure.

FIG. 4 illustrates a hub assembly according to some embodiments of the present disclosure.

FIG. 5 illustrates a hub assembly according to some embodiments of

the present disclosure.

FIG. 6 illustrates a hub assembly according to some embodiments of the present disclosure.

FIG. 7 illustrates a hub assembly according to some embodiments of the present disclosure.

It is to be understood that both the foregoing general description and the following detailed description are exemplary and explanatory only and are not restrictive of the scope of the invention.

### DETAILED DESCRIPTION

Reference will now be made in detail to exemplary embodiments, some examples of which are shown in the accompanying drawings.

To facilitate an understanding of the principles and features of the invention, various illustrative embodiments are explained below. In particular, the presently disclosed subject matter is described in the context of systems and methods for vehicles comprising one or more rotors. In some embodiments, the operation of a hub configured to operate on a vehicle, such as a vertical take-off and landing aircraft. As used herein, vertical and horizontal are used to generally refer to directions relative to a ground plane when the vehicle is at rest (e.g., before take-off), but it is understood that a vehicle may change orientations relative to the ground plane during operation. In a vertical take-off and landing craft, the hub may be configured to operate in two configurations that are substantially perpendicular to each other. For example, the hub may be configured to operate in a substantially vertical configuration for example, for take-off and the hub may be configured to operate in a substantially horizontal configuration for example, for cruise.

Exemplary disclosed embodiments include apparatus, systems, and methods for a rotor hub assembly. In one embodiment, the hub assembly may be used in an aircraft comprising an airframe structure, such as structure of a wing, boom, fuselage, empennage, or undercarriage. In other embodiments, a hub assembly consistent with disclosed embodiments may be used on a number of vehicles, including fixed-wing aircraft, helicopters, boats, cars, or vertical take-off and lift aircraft (VTOL). It is envisioned that the vehicles may be used for any purpose known to those skilled in the art, including for example, as a taxi, a delivery vehicle, a personal vehicle, a cargo transport, a short or long-distance hauling aircraft, and/or a video/photography craft.

As a person of ordinary skill in the art will recognize, the disclosed embodiments are intended to reduce weight and space requirements of a hub assembly and minimize a profile of the hub to reduce drag. Additionally, the hub assembly may allow for duplicative load paths so that the hub assembly may handle a variety of vehicle or aircraft maneuvers and/or situations, including situations caused by extreme weather, mechanical failure, or crash. In some embodiments, the hub assembly may include an alternative load path if a primary load path fails. The hub assembly may reduce a number of components so as to reduce maintenance and it may include components that require less maintenance.

In some embodiments, the rotor hub assembly may also be configured to reduce a risk of whirl flutter in horizontal travel, for example, by providing a stiff structure in an in-craft direction. Additionally, in some embodiments, the hub assembly may be configured to reduce the need for a number of critical components, for example, by using a pin to attach a blade to the inboard elastomeric bearing and the pitch horn. The hub assembly may also be configured to provide redundant load paths, for example, by the outboard elastomeric bearing reacting to a centrifugal force as a fail-safe condition if the inboard elastomeric bearing fails. The hub assembly may be configured to use elastomeric bearings to reduce or eliminate a need for lubrication and/or inspections. In some embodiments, failure modes of a hub assembly may be detectable by one or more sensors. In some embodiments, the one or more sensors may be attached to the airframe or other vehicle structure. In some embodiments, the one or more sensors may detect a vibration or other physical movement.

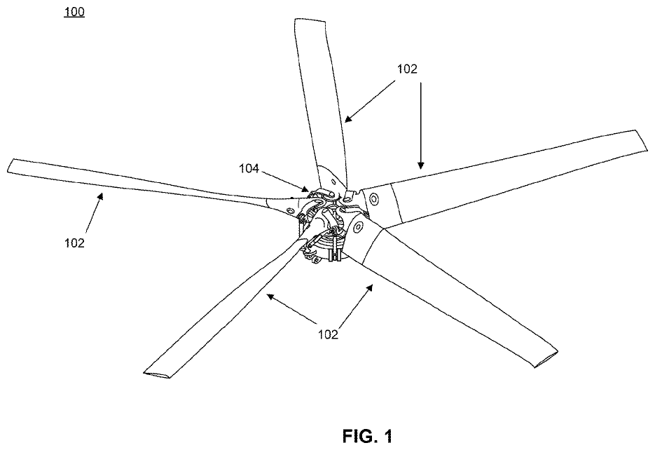

FIGS. 1-6 illustrate non-limiting embodiments of hub assemblies consistent with the present disclosure. It should be understood that the examples and embodiments described represent simplified descriptions used to facilitate understanding of the principles and methods of this disclosure.

FIG. 1 shows an exemplary embodiment of hub assembly 100. Hub assembly 100 may comprise blades 102 and hub 104. Blades 102 may be configured to move around and/or relative to a center of hub 104. Blades 102 may comprise five blades, as shown in FIG. 1. In some embodiments, blades 102 may comprise fewer than five blades or more than five blades. Hub 104 may be configured to move with blades 102. Hub 104 may be attached to blades 102 through one or more of a press fit, a weld, a bolt, a pin, or other methods of attachment known to one of ordinary skill in the art. Blades 102 may comprise a composite material, a metal, a plastic, or other material known to one of ordinary skill in the art. A rotor mast (not shown) may extend from an airframe to rotate hub 104 and blades 102. The rotor mast may be configured to be driven by a drive shaft (not shown). The drive shaft may be configured to be driven by a motor (not shown).

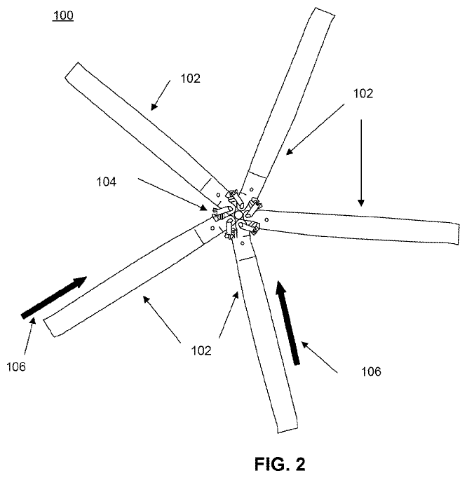

FIGS. 2-7 show exemplary embodiments of hub assembly 100. Although similar or the same numerals are used in each figure, each figure shows an embodiment of hub assembly 100 and features may change from figure to figure as described or illustrated for each figure. Certain features of hub assembly 100 are not shown or discussed in these examples where such features may be similar to those discussed for other embodiments.

FIG. 2 shows an exemplary embodiment of hub assembly 100 having an inboard direction (shown as 106), which is the direction towards a center of hub 104. Conversely, an outboard direction (not shown) is the opposite direction—i.e., the direction away from a center of hub 104. Although a specific direction of inboard direction 106 is indicated in FIG. 2, a reference to inboard or outboard directions is merely meant as a reference to a direction in the figure relative to the other illustrated components of hub assembly 100, and is not otherwise intended to be limiting.

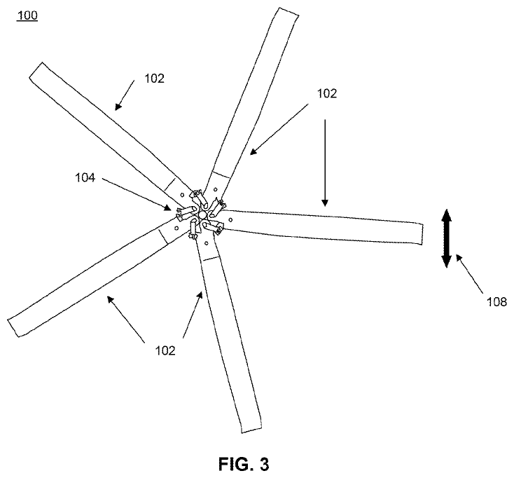

FIG. 3 shows an exemplary embodiment of hub assembly 100 having an in-plane direction (shown as 108), which is a direction transverse to hub 104 and/or blades 102. Although a specific direction of in-plane direction 108 is indicated in FIG. 3, any reference to in-plane direction is a reference to a direction in the figure relative to the other illustrated components of hub assembly 100, and is not otherwise intended to be limiting.

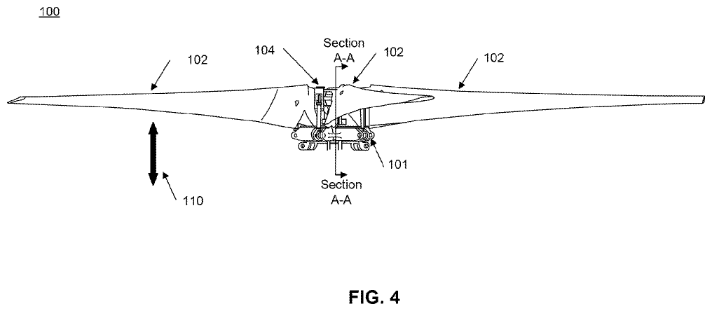

FIG. 4 shows an exemplary embodiment of hub assembly 100 having an out-of-plane direction (shown as 110), which is a direction perpendicular to hub 104 and/or blades 102. Although a specific direction of out-of-plane direction 110 is indicated in FIG. 4, any reference to out-of-plane direction is a reference to a direction in the figure relative to the other illustrated components of hub assembly 100, and is not otherwise intended to be limiting.

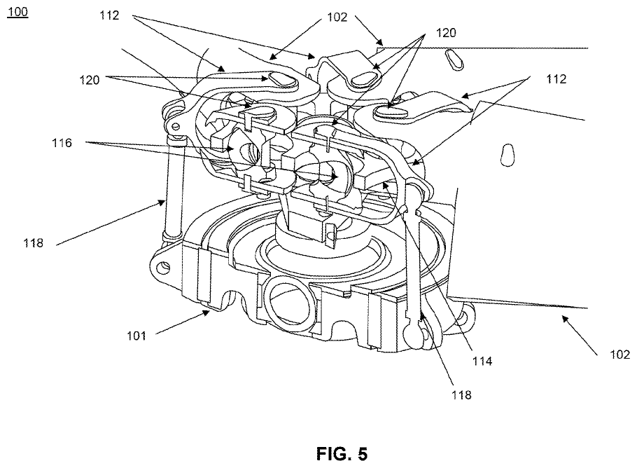

FIG. 5 shows an exemplary embodiment of hub assembly 100. Hub assembly 100 may comprise pitch control mechanism 101 (e.g., a swashplate or a controller configured to actuate a link or a connection to a blade), pitch horns 112, a yoke 114, inboard elastomeric bearings 116, links 118, and pins 120. Hub assembly 100 may further comprise outboard elastomeric bearing 122 (not shown in FIG. 5). As a person of ordinary skill in the art will understand, hub assembly 100 may comprise, for each blade 102, at least one pitch horn 112 and at least one link 118.

Pitch horn 112 may be configured to adjust a pitch of blade 102. In some embodiments, pitch horn 112 may be actuated to adjust a pitch of blade 102, where the actuation is controlled by a pitch control mechanism. Pitch horn 112 may be attached at a top surface of blade 102 and/or a bottom surface of blade 102. Pitch horn 112 may be attached to link 118. Pitch horn 112 may extend in an outboard direction, as discussed above with reference to FIG. 2, from an attachment to blade 102. The attachment of pitch horn 112 to link 118 may be in an outboard direction from the attachment of pitch horn 112 to blade 102. Blades 102 may comprise an integral root cuff for attachment to inboard elastomeric bearing 116. Blades 102 may comprise a first flange and a second flange. Inboard elastomeric bearing 116 and/or outboard elastomeric bearing 122 may be between the first flange and the second flange.

In some embodiments, yoke 114 may be configured to transmit mechanical energy from a rotor mast (not shown) to blades 102. In some embodiments, yoke 114 may be attached to a rotor mast through a cone and a spline. In some embodiments, yoke 114 may be attached to blades 102, inboard elastomeric bearings 116, and a rotor mast from the airframe.

In some embodiments, inboard elastomeric bearing 116 and outboard elastomeric bearing 122 each may comprise an elastomer layer and a metal layer. Inboard elastomeric bearing 116 and outboard elastomeric bearing 122 each may be configured to support simultaneous loads and deformation in more than one direction. Inboard elastomeric bearing 116 and outboard elastomeric bearing 122 each may comprise a butyl rubber or other substance known to those skilled in the art for creating a rotor bearing. Inboard elastomeric bearing 116 and outboard elastomeric bearing 122 each may be configured to allow for a change in pitch of blades 102. In some embodiments, the pitch of each blade 102 may be changed separately, or the pitch of all of the blades may be changed at the same time by differing amounts or the same amount. Further, each blade may have its own pitch controller or one pitch controller may be used to control multiple blades.

In some embodiments, inboard elastomeric bearing 116 and outboard elastomeric bearing 122 each may be configured to bear out-of-plane and in-plane shear forces. Inboard elastomeric bearing 116 and outboard elastomeric bearing 122 each may be configured to bear shear forces parallel to an out-of-plane axis and an in-plane axis. Inboard elastomeric bearing 116 and outboard elastomeric bearing 122 each may comprise a stiffness that allows for a relatively high hub moment when a cyclic pitch change is applied, where the cyclic pitch change induces a variation in thrust around the azimuth of the rotor disk. In some embodiments, the use of inboard elastomeric bearing 116 and outboard elastomeric bearing 122 may reduce and/or eliminate a need for lubrication. In some embodiments, the need for ultrasonic inspections may be reduced and/or eliminated because the hub and elastomeric bearings may be inspected visually without the need for disassembly.

In some embodiments, inboard elastomeric bearing 116 may be attached to pitch horn 112, blade 102, and/or yoke 114. In some embodiments, pin 120 may be configured to hold pitch horn 112, blade 112, and/or inboard elastomeric bearing 116 together.

In some embodiments, link 118 may be attached to pitch control mechanism 101 (partly shown). Link 118 may extend along out-of-plane direction 110, as discussed above with reference to FIG. 4. In some embodiments, the attachment of link 118 to pitch horn 112 may be along out-of-plane direction 110 and away from an airframe from the attachment of link 118 to pitch control mechanism 101. In some embodiments, link 118 may comprise a tie-rod.

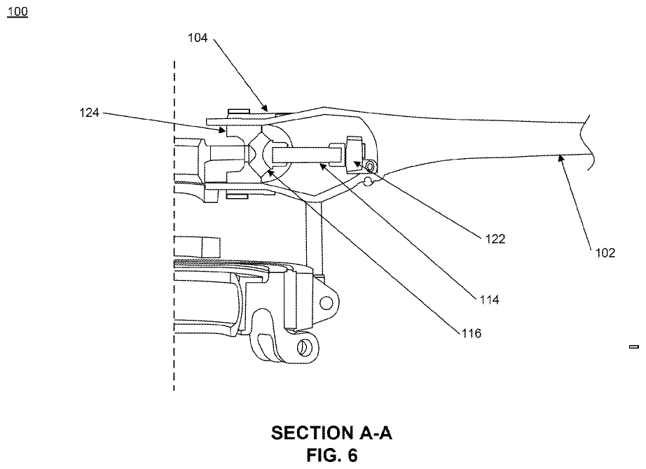

FIG. 6 shows an exemplary embodiment of hub assembly 100. As shown in FIG. 6, in some embodiments, inboard elastomeric bearing 116 may be configured to attach at an upper attachment to blade 102 and a lower attachment to blade 102. In some embodiments, inboard elastomeric bearing 116 may extend in an outboard direction from an attachment to blade 102. In some embodiments, inboard elastomeric bearing 116 may extend in an outboard direction, as discussed above with reference to FIG. 2, from an attachment to blade 102. In some embodiments, the attachment of inboard elastomeric bearing 116 to yoke 114 may be in an outboard direction from the attachment of inboard elastomeric bearing 116 to blade 102. In some embodiments, a conic shape of inboard elastomeric bearing 116 may serve to react the centrifugal force of blade 102. It is contemplated that the inboard elastomeric bearing 116 may comprise a conic shape, a cylindrical shape, a circular shape, or any other shape known to one of ordinary skill in the art for an elastomeric bearing.

In some embodiments, outboard elastomeric bearing 122 may attach to yoke 114 and blade 102. It is contemplated that the outboard elastomeric bearing 122 may comprise a conic shape, a cylindrical shape, a circular shape, or any other shape known to one of ordinary skill in the art for an elastomeric bearing. In some embodiments, a cylindrical shape of the elastomer pack of the outboard bearing 122 may allow it to stretch in the outboard direction so it does not react centrifugal force under normal operation. In some embodiments, a pin (not shown in FIG. 6) may be configured to hold blade 102 and outboard elastomeric bearing 122. In some embodiments, blades 102 may comprise an integral root cuff for attachment to outboard elastomeric bearing 122. The integral root cuff may avoid the need for a blade grip. In some embodiments, outboard elastomeric bearing 122 may be in an outboard direction from inboard elastomeric bearing 116. In some embodiments, outboard elastomeric bearing 122 may be configured to bear a centrifugal force if inboard elastomeric bearing 116 fails to bear the centrifugal force of blades 102. For example, if inboard bearing 116 begins to fail it may gradually stop reacting centrifugal force and a fail safe feature of the outboard bearing 122 may begin to carry centrifugal force. Under this scenario, rotor 100 may begin to vibrate, by design, allowing a sensor (not shown) attached to the airframe to detect the imminent failure and notify the pilot or flight computer to take action. Other conditions may lead to the outboard bearing 122 carrying centrifugal force as would be known to one of ordinary skill in the art. The sensor may be configured to sense one or more failure conditions including vibration, separation, fracturing, a threshold force, or another failure condition as would be understood to one of ordinary skill in the art. In some embodiments, the sensor may be an accelerometer.

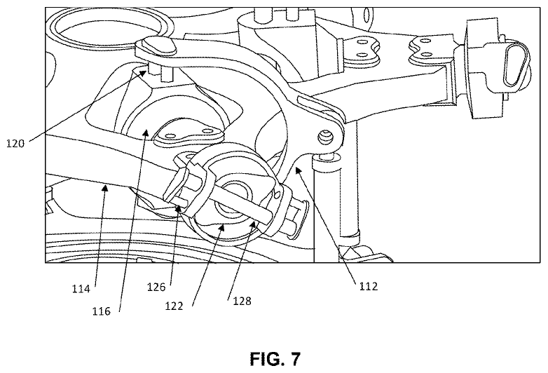

FIG. 7 shows an exemplary embodiment of hub assembly 100. As shown in FIG. 7, in some embodiments, inboard elastomeric bearing 116 may be configured to attach to blade 102 (not shown) and/or pitch horn 112 by pin 120. Inboard elastomeric bearing 116 may be configured to be attached to yoke 114 with one or more pins or similar to prevent rotation. Outboard elastomeric bearing 122 may be configured to attach to blade 102 (not shown) by pin 128. Pin 128 may include anti-rotation pin 126. Pin 120 may include an anti-rotation pin. Outboard elastomeric bearing 122 may be configured to attach to yoke 114. Pin 128 may be at an angle to accommodate an angled surface of blade 102 (not shown) relative to yoke 114.

Improved hubs can be incorporated into a vehicle to provide efficient load transmission, to provide a reduction in a number of components of a hub, to reduce maintenance, and to provide a fail-safe condition. Improved hubs consistent with the present disclosure can be incorporated into the vehicle as a system or a method. For example, a method for providing lift or thrust to a vehicle may include steps of transmitting mechanical energy from a motor to at least two blades (e.g., blades 102) through a drive shaft and a rotor mast, supporting one blade of the at least two blades through a hub (e.g., hub assembly 100) comprising an inboard elastomeric bearing (e.g., inboard elastomeric bearing 116) and an outboard elastomeric bearing (e.g., outboard elastomeric bearing 122), wherein the one blade is attached to the inboard elastomeric bearing and the outboard elastomeric bearing; transmitting a substantially out-of-plane force (e.g., in direction 110) from the one blade to the inboard elastomeric bearing and the outboard elastomeric bearing; transmitting a substantially in-plane force (e.g., in direction 108) to the inboard elastomeric bearing and the outboard elastomeric bearing; and adjusting a pitch of the one blade through a pitch horn, (e.g., pitch horn 112) wherein the pitch horn is attached at the inboard elastomeric bearing. In some embodiments, the one blade (e.g., blade 102) may comprise a first flange and a second flange (e.g., a root cuff), and wherein the inboard elastomeric bearing and the outboard elastomeric bearing are between the first flange and the second flange. The vehicle may be an aircraft. The vehicle may be a vertical take-off and landing craft vehicle.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. In particular aspects of the present disclosure have been described as relating to systems and methods for providing a vertical take-off craft. Additionally, other equivalent methods or composition to these described aspects are also contemplated by the teachings herein. Therefore, the present disclosure should not be limited to any single aspect, but rather construed in breadth and scope in accordance with the appended claims.

What is claimed is:

1. A hub comprising:
at least two rotor blades;
a motor mechanically connected to the at least two rotor blades to rotate the at least two blades, wherein the motor is attached to a frame; and
a hub configured to transmit loads from the at least two rotor blades to the frame, wherein one rotor blade of the at least two rotor blades is coupled to an inboard elastomeric bearing attached to the hub and coupled to an outboard elastomeric bearing attached to the hub.

2. The hub of claim 1, wherein the hub is configured to operate in two configurations that are substantially perpendicular to each other.

3. The hub of claim 1, wherein the hub comprises a pitch horn configured to couple one of the at least two rotor blades at an attachment to the inboard elastomeric bearing.

4. The hub of claim 3, wherein the hub comprises a link configured to couple the pitch horn to a pitch controller.

5. The hub of claim 3, wherein the hub is configured to transmit a substantially in-plane force from the inboard elastomeric bearing and the outboard elastomeric bearing to the one blade.

6. The hub of claim 1, wherein the inboard elastomeric bearing is configured to bear the centrifugal force of one of the at least two rotor blades in compression.

7. The hub of claim 1, wherein the outboard elastomeric bearing is configured to bear a centrifugal force of one of the at least two rotor blades if the inboard elastomeric bearing fails to bear the centrifugal force of the one blade.

8. The hub of claim 1, wherein the inboard elastomeric bearing and the outboard elastomeric bearing allow for a change in pitch of the hub.

9. The hub of claim 1, wherein the inboard elastomeric bearing and the outboard elastomeric bearing are each configured to allow for a change in pitch of one of the at least two rotor blades.

10. The hub of claim 1, wherein the frame or the hub comprises a sensor configured to sense a failure mode of one or more of the inboard elastomeric bearing and the outboard elastomeric bearing.

11. A hub assembly, the hub assembly comprising:
a yoke;
at least one inboard elastomeric bearing attached to the yoke;
at least one outboard elastomeric bearing attached to the yoke; and
at least two rotor blades configured to generate thrust, wherein one rotor blade of the at least two rotor blades is coupled to an inboard elastomeric bearing, and wherein the one rotor blade of the at least two rotor blades is coupled to an outboard elastomeric bearing.

12. The hub assembly of claim 11, wherein one of the at least two rotor blades comprises a first flange and a second flange, and wherein the inboard elastomeric bearing is between the first flange and the second flange.

13. The hub assembly of claim 11 further comprising a pitch horn configured to couple to one of the at least two rotor blades at the inboard elastomeric bearing.

14. The hub assembly of claim 11, wherein the yoke is configured to transmit a substantially in-plane load to one of the at least two rotor blades through the inboard elastomeric bearing and the outboard elastomeric bearing.

15. The hub assembly of claim 11, wherein one of the at least two rotor blades is configured to operate to generate vertical lift for a vertical take-off configuration of an aircraft, and wherein the one blade is configured to generate substantially horizontal thrust for a horizontal flight configuration of an aircraft.

16. The hub assembly of claim 11, wherein the inboard elastomeric bearing is configured to bear a centrifugal force of one of the at least two rotor blades.

17. The hub assembly of claim 11, wherein the outboard elastomeric bearing is configured to bear a centrifugal force of one of the at least two rotor blades if the inboard elastomeric bearing fails to bear the centrifugal force of the one blade.

18. The hub assembly of claim 11, wherein each of the outboard elastomeric bearing and the inboard elastomeric bearing comprises an elastomer layer and a metal layer.

19. A method of providing lift or thrust to a vehicle, the method comprising steps of:
transmitting mechanical energy from a motor to at least two rotor blades through a drive shaft and a rotor mast,
supporting one rotor blade of the at least two rotor blades through a hub comprising an inboard elastomeric bearing and an outboard elastomeric bearing, wherein the one blade is attached to the inboard elastomeric bearing and the outboard elastomeric bearing;
transmitting a substantially out-of-plane force from the one rotor blade to the inboard elastomeric bearing and the outboard elastomeric bearing;
transmitting a substantially in-plane force to the inboard elastomeric bearing and the outboard elastomeric bearing; and
adjusting a pitch of the one rotor blade through a pitch horn, wherein the pitch horn is attached at the inboard elastomeric bearing.

20. The method of claim 19, wherein one of the at least two rotor blades comprises a first flange and a second flange, and wherein the inboard elastomeric bearing and the outboard elastomeric bearing are between the first flange and the second flange.
